(19) United States
(12) Patent Application Publication
(10) Pub. No.: US 2007/0124974 A1
(43) Pub. Date: Jun. 7, 2007

(54) Clip-on organizing and teaching system

(76) Inventor: Esther Nichole Lanier, Milwaukee, WI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/280,564

(22) Filed: Nov. 16, 2005

(51) Int. Cl. G09F 3/20

(52) U.S. Cl. 40/658

(57) ABSTRACT

An organizing system and method that includes a housing configured to secure to a drawer, shelf, toy box or other storage container and an insert removably secured within the housing. The insert bears indicia, emblems, colors and/or pictures displaying clothing, household and/or personal items within the drawer, shelf or other storage container onto which the system is secured. The system enables an individual to view the picture thereon and recognize the correct location for the item The system may be provided with a plurality of removable inserts, and therefore the outside appearance of the organizing system, may be changed whenever the contents of the drawer or room dé cor changes. In this manner, the individual is taught the proper location for their items so that they may be put away and taken out without assistance.

### BACKGROUND OF THE INVENTION

### Field of the Invention

The present invention relates generally to an identification system for organizing the contents of a drawer, shelf, cabinet or other storage container, and more particularly to, an organizing system for educating and/or assisting individuals in identifying and organizing the contents of a drawer, shelf, cabinet or other storage container.

Individuals, and in particular, special needs children and adults such as those with attention deficit disorder (ADD), attention deficit hyperactive disorder (ADHD), or autism, strive for independence in daily living. Indeed, teaching children the skills needed for independent living, such as dressing themselves and putting away and finding belongings, is critical in fostering confidence and personal responsibility.

Accordingly, children or individuals with special needs are typically taught to care for themselves using recognizable routines, familiar shapes or colors, and/or visual indicators and feed back that are easy for the individual to recognize and understand. Once the individual learns the new skill, it can instill pride and confidence in the individual, as well as provide the caregiver or parent a well needed break or opportunity to focus on other matters.

However, learning new skills can be frustrating for both the child and the parent. Special needs children can suffer from lack of self-esteem, and can get easily frustrated. Further, basic skills, such as learning to dress oneself, coordinating colors and appropriate clothing items, and/or putting away items in a kitchen or bathroom can be difficult for some individuals to do without assistance.

It is accordingly the primary objective of the present invention to provide a removable system for organizing the contents of a drawer, container and/or shelf, thereby assisting in the independence of individuals with special needs, young children and/or the organizationally challegenged. It is a related objective of the present invention to provide a removable, clip-on organizing system bearing a visual sign, symbol, picture, indicia or other pattern that is easily recognized and/or interpreted by the individual to correspond to the contents of the container onto which it is placed —teaching the individual the appropriate location for the item and/or belonging.

It can be another objective of the present invention to provide a removable device for organizing the contents of a drawer, container and/or shelf that provides a visual, color-coded and/or designed appearance on the outside of or conveniently on the inside of the drawer, shelf or container to facilitate recognition by the individual of the contents of the drawer and/or to teach the individual the proper location for such items within the drawer. Accordingly, it can be a related objective of the present invention to provide a removable organizing device including indicia, emblems, shapes, colors, designs and/or patterns that can be coordinated to correspond to the contents/items located in the drawer or container, to the individual's room decor and/or the particular space/location in which the device will be located.

It can be a further objective of the present invention to provide a method for teaching organizational skills to an individual with special needs, wherein the method includes: providing a removable organizing device configured to removably secure to a drawer, shelf or other storage container, the device including a retaining mechanism for securing a substantially flat substrate therein; providing a substrate bearing indicia, emblems, colors and/or a picture that clearly displays an item or otherwise coordinates with the articles within the drawer, shelf, or other storage container; securing the substrate using the retaining mechanism; removably securing the device to the drawer, shelf or other storage container in a manner that permits the individual to view the device thereon and recognize that the indicia applied to the substrate corresponds to the items in the drawer, shelf, or other storage container.

The organizing system of the present invention must also be of construction which is both durable and long lasting, and it should also require little or no maintenance to be provided by the user throughout its operating lifetime. In order to enhance the market appeal of the organizing system of the present invention, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, an organizing system and method of teaching organization skills is provided to assist in the independence of individuals with special needs, young children and/or the organizationally challenged. While the system of the present invention is described with reference to use on a drawer, it will be appreciated that the present invention can be used on any shelf, storage enclosure, toy box, closet, cabinet, furniture item and/or appliance (i.e. refrigerator) without substantial modification from the preferred, drawer-type embodiment thereof.

The organizing system of the present invention includes an organizing device and a plurality of inserts for use therein—each of the inserts bearing a visual sign, indicia, symbol, image or other visual picture depicting a common clothing, household or personal item.

The organizing device includes a housing member having a display portion and a mounting portion/mechanism that is joined to and extending rearwardly from the display portion. The display portion and the mounting portion of the device are preferably integrally formed such that the device is of a single or unitary construction and the display portion is substantially fixed with respect to the mounting portion. Alternatively, the organizing device may be constructed of two or more pieces, wherein the display portion is mechanically or otherwise joined to the mounting portion.

The organizing device and in particular, the display portion of the device, is preferably constructed of a transparent and/or substantially transparent material. Such material can include thermoplastics and/or thermosets including, but not limited to, polyvinyl chloride, polypropylene, polyethylene, polystyrene, and/or nylon. Additional materials of construction contemplated by the present invention for use in either the display portion or the mounting portion can include such materials as wood, metal or a plastic composite material.

The mounting mechanism/portion of the organizing device is configured substantially in the form of a bracket that extends rearwardly from the display portion. The bracket has a top side that is large enough to fit over the top, frontmost edge of a number of different sized drawers. The rear leg of the bracket of the mounting mechanism angles forward toward the display portion of the device, resulting in a constriction or narrowed area at the bottom portion of the bracket—permitting the mounting portion of the organizing device to be wider at its top than its bottom so that the system may be clipped and held into place with such rear leg.

As will at once be appreciated by one skilled in the art, the organizing device of the present invention is adjustable and therefore designed to fit a number of different size drawers and/or storage containers, etc. Indeed, because mounting portion includes a bracket that angles away from the display portion and has a leg that angles back toward the display portion, the organizing device clips over the top edge of the drawer and is held in place by the leg. Such adjustability and/or clipping action of the system of the present invention can be facilitated and/or controlled by not only the relative size of the mounting mechanism, bracket, and the degree of angle of the rear leg but also the relative flexibility and/or rigidity of the material of construction of the organizing device.

The display portion of the system of the present invention is substantially flat having a front side and back side and top and bottom sides. The display portion is sized depending on the specific application of use of the organizing device, for example, the type of enclosure and/or furniture onto which the system will be installed, the sophistication of the user and/or the size and number of the inserts.

A flange extends downwardly from the top side of the display portion on the back side thereof forming a channel that extends the entire width of the housing member. Likewise, a flange extends upwardly from the bottom side of the display portion on the back side thereof forming a channel extends the entire width of the housing member. The channels are located substantially parallel to each other and spaced-apart along the top and bottom sides of the display portion respectively. The channels are sized to slidably fit and retain one or more inserts and therefore, can vary depending on the type of insert used in the system.

An insert for use in the organizing system of the present invention includes indicia, symbols, images or other easily recognizable and/or clearly identifiable pictures of common clothing, household and/or personal items. Accordingly, such items include, but are not limited to: clothing items (shirts, pants, socks, shoes, underwear, etc.), household items (spoon, blanket, tools, scissors, etc.), personal items (toothbrush, medicine, toys, etc.) and/or items such as foods and drinks—depending on the intended location of the system. Preferably, each insert provided with the system of the present invention has substantially the same width and length dimensions as the display portion of the organizing device such that the insert occupies the entire front face of the display portion.

Preferably, each insert is formed of overlapping and separable layers. As such, the item or items to be displayed on the front face of the insert can be formed by including a cutout or stencil of such items in the one or more of the layers. As such, when the layers are arranged in an overlapping fashion, the lower layers will show through the stencil or cutouts in the additional overlying layers to display the picture on the front face of the insert. The inserts for use in the present invention may comprise any number of layers, provided the insert (i.e. the combined layers) is sized to fit within the retaining channels of the display portion.

Likewise, the number of visual signs, indicia, symbols, images, pictures that are visually displayed on the insert can vary depending on the given end-use application of the system. For example, each insert may include more than one image or picture so that the device may be used to display a picture of every item within the drawer on which it is to be used.

The color and/or texture of each of the inserts provided in with the system of the present invention is a matter of design choice. Accordingly, the layers of the insert can be constructed in one or more colors and may optionally contain any surface texture, design or pattern, in addition to the cutouts or stencils. In addition, each surface or side of the layers may be a different color, texture or patter, and thus reversible, if desired. Preferably, the layers comprising the inserts for use in the present invention match the color and/or otherwise visually coordinate with the room or other environment of the location of the system. As will at once be appreciated by those skilled in the art, because the layers are removable from the organizing device and separable from each other, the look of the insert can be changed as a matter of design choice by substituting one or more of the layers with different or alternate layers constructed of a different color, texture, design or pattern and/or containing a stencil or cutout in a different shape.

The inserts for use with the present invention may also be constructed of a single layer of material bearing a visual sign, indicia, symbol, image or other picture such as a clothing, household and/or personal item on at least one of its two surfaces. Such pictures may be applied to the single-layered insert using any method known to those skilled in the art, such as printing or embossing.

Accordingly, the organizing system is utilized by selecting and/or preparing an insert bearing a picture of the item or items that are contained within the drawer or location on which the system is to be installed. In addition, the color, design or pattern contained on the insert can be coordinated to match the environment of the system (i.e. the room in which the system is installed). After selection of the insert is made, the insert is installed into the organizing device by sliding the insert into the top and bottom channels on the rear side of the display portion of the organizing device.

The system is then removably mounted to the dresser by clipping the mounting portion over the top edge of the drawer. When the system is clipped or otherwise installed on the dresser, the display portion is substantially flush with/parallel to the dresser drawer and does not interfere with use of the dresser and/or cause unneeded interference or distraction in the individual's room. However, because the display portion is constructed of a transparent material, the visual signs, indicia, symbols, images, pictures and/or cutouts disposed on the front face of the insert will be displayed on the outside face the drawer, identifying the contents of the drawer, and therefore, teaching the individual the correct location for the item and/or belonging. When the system is no longer needed or is moved to a different location, it can be removed from the dresser by releasing the mounting portion from the drawer. Likewise, the system may be removed from its location when the insert is changed; however, it is not necessary to remove the system to change the inserts.

The organizing system of the present invention is of a construction which is both durable and long lasting, and which will require little or no maintenance to be provided by the user throughout its operating lifetime. The organizing system of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is a perspective view of a dresser with a preferred embodiment of the organizing system of the present invention removably secured to a drawer;

FIG. 2 is a perspective view the organizing system illustrated in FIG. 2;

FIG. 3 is a side view of a housing member of the organizing system illustrated in FIG. 1, taken along the line 3-3, shown clipped over the drawer;

FIG. 4 is a rear view of the housing member of the organizing system illustrated in FIGS. 1 through 3;

FIG. 5A is a perspective view of a preferred embodiment of the insert for use in the organizing system of the present invention;

FIG. 5B is a partial sectional view of the insert illustrated in FIG. 5A taken along the line 5B-5B;

FIG. 5C is a partial sectional view of an alternate embodiment of an insert for use with the organizing system of the present invention, illustrating a multilayered insert comprising more than one layer of cutouts;

FIG. 6 is a perspective view of an additional alternate embodiment of an insert for use in the organizing system of the present invention;

FIG. 7A is a perspective view of a first alternate embodiment of the organizing system of the present invention, illustrating two display portions and two inserts therein;

FIG. 7B is a side view of a housing member of the organizing system illustrated in FIG. 7A;

FIG. 8A is a side view of a second alternate embodiment of the organizing system of the present invention mounted to a shelf;

FIG. 8B is a front view of a third alternate embodiment of the organizing system of the present invention mounted to a knob of a cabinet;

FIG. 8C is a front view of a fourth alternate embodiment of the organizing system of the present invention incorporated into a knob of a drawer or a cabinet;

FIG. 8D is a side view the alternate embodiment of the organizing system illustrated in FIG. 8C; and

FIG. 9 is a side view of a fifth alternate embodiment of the organizing system of the present invention, illustrating the insert slidably mounted on the front side of the display portion of the housing member.

### DETAILED DESCRIPTION OF THE PREFERRED EMBODIMENT

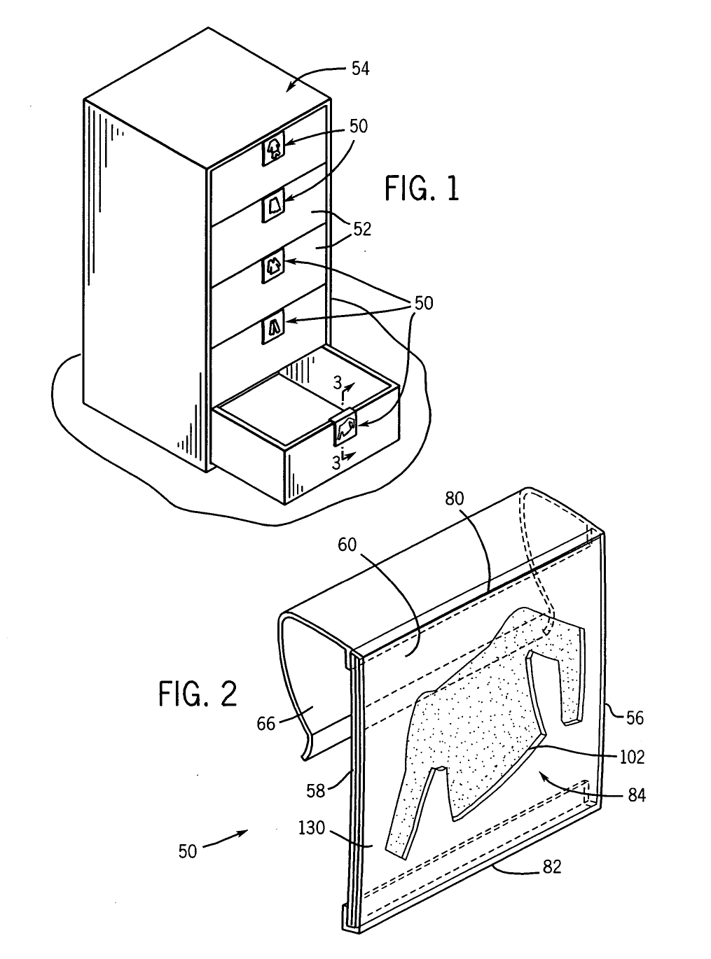

The preferred embodiment of an organizing system 50 of the present invention is described with reference to a preferred embodiment which is configured to removably mount to a drawer 52 of a dresser 54, as illustrated in FIG. 1. It will be appreciated by those skilled in the art the system of the present invention may be configured to mount to any drawer, shelf, cabinet, toy box, storage container, bin, basket, enclosure and/or appliance to educate and/or assist an individual in identifying and organizing personal and/or household items.

Turning first to FIG. 2, in addition to FIG. 1, the organizing system 50 of 10 the present invention in its simplest form includes a housing member 56 and a removable card, substrate and/or insert 58 bearing a recognizable clothing, personal and/or household item, as will be described in more detail below.

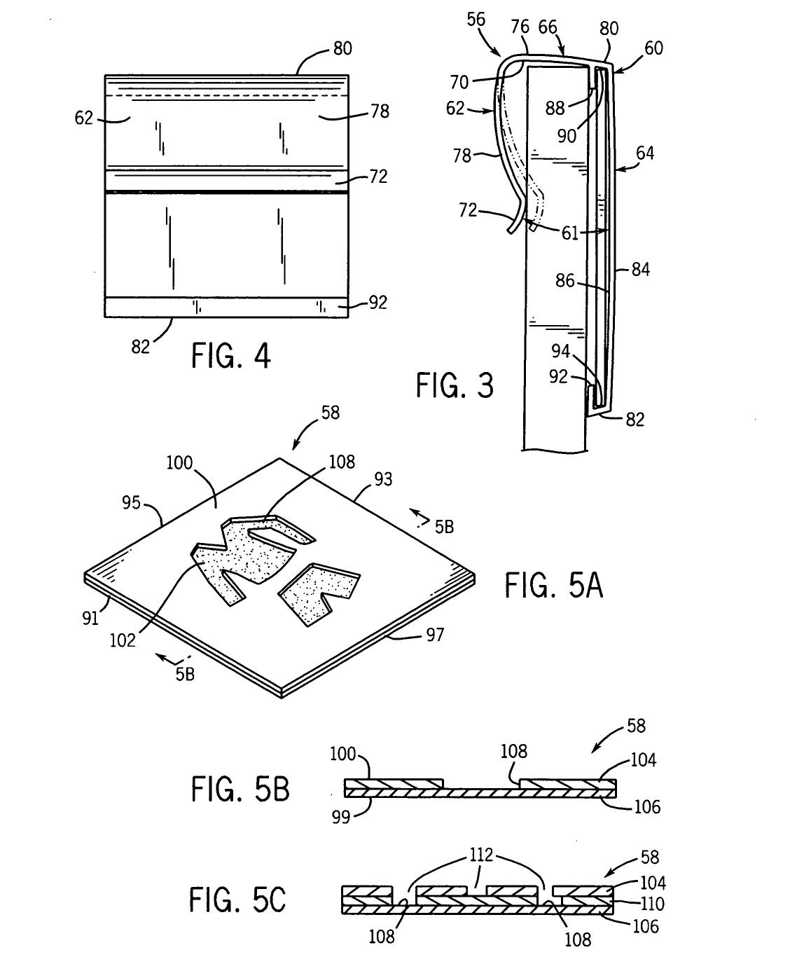

As illustrated in FIGS. 3 and 4, the housing member 56 has a front side, indicated generally at 60, a rear side, indicated generally at 62, a display portion 64 on the front side 60 thereof and a mounting portion 66 joined to and extending rearwardly from the display portion 64. The housing member 56 is preferably constructed as a single, unitary device wherein the display portion 64 is integrally formed with and joined to the mounting portion 66. Consistent with the broader aspects of the present invention, and as described in more detail with respect to alternate embodiments, the housing member 56 may be constructed of two or more pieces, such that the display portion 64 is mechanically or otherwise joined to the mounting portion 66.

The housing member 56 is constructed of a thermoplastic material, and preferably, a transparent and/or substantially transparent material including, but not limited to, polyvinyl chloride, polypropylene, polyethylene, polystyrene, and/or nylon. The specific thermoplastic used can depend on the given end-use application for the system 50, including, but not limited to, such factors as the particular location to which the system will mount (i.e. dresser, shelf, refrigerator, drawer), the conditions of use, the age of the individual using the system, the decor of the surroundings/environment of the system and/or the required rigidity and/or flexibility required for the system 50 to function as a teaching and/or organizing tool.

Alternatively, where the housing member 56 is constructed of two or more pieces, the display portion 64 and the mounting portion 66 may be constructed of the same or different materials. Additional materials of construction contemplated by the present invention for use in either the display portion 64 of the mounting portion 66 or both can include such materials as wood, metal or a plastic composite material.

As best illustrated in FIG. 3, the mounting portion 66 is configured substantially in the form of a bracket or channel member, having a channel portion, indicated generally at 70 that extends rearwardly from the display portion 64 and an end 72. The channel portion 70 is sized to fit over the top edge of the front face of the drawer 52, and has a top edge 76 that is relatively thin and/or configured to permit the drawer 52 to completely or fully close when the system 50 is positioned in place. A downwardly extending leg 78 of the channel portion 70 extends towards the display portion 64 on the front side 60 of the housing member 56 forming a constriction/narrowed area 61 —permitting the mounting portion to be wider at its top than its bottom so that the system 50 may be clipped in place.

As will at once be appreciated by one skilled in the art, the mounting portion 66 is adjustable and therefore designed to fit a number of different size drawers. Indeed, the top edge 76 of the channel portion 70 may be sized so that it is adequately large enough to fit over the top edge of a number of different drawers. Because the leg 78 angles toward the display portion 64, the mounting portion 66 of the housing member 56 clips over the top edge of the drawer and is held in place by the end 72. Such adjustability and/or clipping action of the system 50 of the present invention can be facilitated and/or controlled by not only the relative size of the channel portion 70, but also the degree of angle of the leg 78 and the relative flexibility and/or rigidity of the material of construction of the housing member 56.

The display portion 64 of the housing member 56 is generally flat and has a top side, indicated generally at 80, a bottom side, indicated generally at 82, a front face 84 and a rear face 86. The size of the display portion 64 depends on the specific application of use, for example, the type of furniture onto which the system will be installed, the sophistication of the user and/or the size and number of the inserts.

A flange 88 extends downwardly from the top side 80 of the display portion 64 forming a channel 90 that extends the entire width of the housing member 56. Likewise, a flange 92 extends upwardly from the bottom side 82 of the display portion 64 forming a channel 94 extends the entire width of the housing member 56. Each of the channels 90 and 94 are sized to fit and retain the insert 58, and therefore, can vary depending on the type of insert used in the system 50.

Turning next to FIGS. 5A and 5B, a preferred configuration for the card or insert 58 is shown. The insert 58 has side edges, 91 and 93, respectively, top and bottom edges 95 and 97, a rear face 99, and a front face 100 bearing a visual sign, indicia, symbol, image or other picture 102 that identifies the item or items within the drawer or container onto which the system will be placed. Preferably, the insert 58 has substantially the same width and length dimensions as the front face 84 of the display portion 64 of the housing member 56 such that the insert 58 occupies the entire front face of the display portion 64.

The insert 58 is formed of overlapping and separable top and bottom layers 104 and 106, respectively. The size and thickness of the layers 104 and 106 depends on the particular type, shape and size of the housing member 56 and can depend on the specific end-use application of the system 50 (i.e. particular location to which the system will mount, the age and/or sophistication of the individual using the system and/or the décor of the surroundings/environment of the system). As illustrated in FIG. 5A, the layers 104 and 106 are preferably substantially the same size.

The layers 104 and 106 of the system 50 of the present invention may be constructed of any substrate provided the insert 58 is configured to be slidably received within the channels 90 and 94 of the housing member 56. Such materials of construction can include, but are not limited to paper, cardboard and/or any cellulose-based material known to those skilled in the art, plastics and related composites thereof, metals, wood, fabric, leather and/or combinations thereof. In addition, the type of material used may be dictated by particular governmental regulations and/or industry standards for such a teaching/organizing system. The layers 104 and 106 are preferably constructed of the same material; however, each layer may be constructed of a different material.

As illustrated in FIG. 5B, the picture 102 of the item or items to be displayed on the front face 100 of the insert 58 is formed by including a die-cut, cutout or stencil 108 of such items in the top layer 104. As such, when the top and bottom layers 104 and 106 are arranged in an overlapping fashion, the second layer 106 shows through the stencil 108 to display the picture 102 on the front face 100 of the insert 58. As illustrated in FIG. 5C and as will be appreciated by those skilled in the art, the insert 58 may comprise more than two layers, including for example, an additional layer 110 located between the top and bottom layers 104 and 106, respectively. The layer 110 may contain additional stencils or cutouts 112 depicting shapes or pictures, as illustrated in FIG. 5C.

The stencil or cutout 108 in the layer 104 is preferably formed in the shape the items within the drawer or container onto which the system will be placed. As such, the visual sign, indicia, symbol, image or other picture 102 can include any item that would be useful in helping to teach an individual the proper location for their belongings and/or to assist the individual to organize their belongings. Accordingly, such items include, but are not limited to: clothing items (shirts, pants, socks, shoes, underwear, etc.), household items (spoon, blanket, tools, scissors, etc.), personal items (toothbrush, medicine, toys, etc.) and/or items such as foods and drinks—depending on the intended location of the system 50.

Likewise, the number of visual signs, indicia, symbols, images, pictures 102 and/or cutouts 108 that are visually displayed on the front face 100 of the insert 58 can vary depending on the given end-use application of the system. For example, the insert 58 may contain a picture of every item within the drawer 52.

The color and/or texture of the insert 58 is a matter of design choice. Accordingly, the layers 104 and 106 can be constructed in any color or color and/or contain any surface texture, design or pattern, in addition to the cutouts 108. In addition, each surface or side of the layers 104 and 106 may be a different color, texture or patter, and thus reversible, if desired. Preferably, the layers 104 and 106 match the color and/or otherwise visually coordinate with the actual items in the drawer, the room or other environment of the location of the system 50. As will at once be appreciated by those skilled in the art, because the layers are removable from the housing member 56 and separable from each other, the look of the insert 58 can be changed as a matter of design choice by substituting one or both of the layers 104 and 106 with different or alternate layers constructed of a different color, texture, design or pattern and/or containing a stencil or cutout in a different shape.

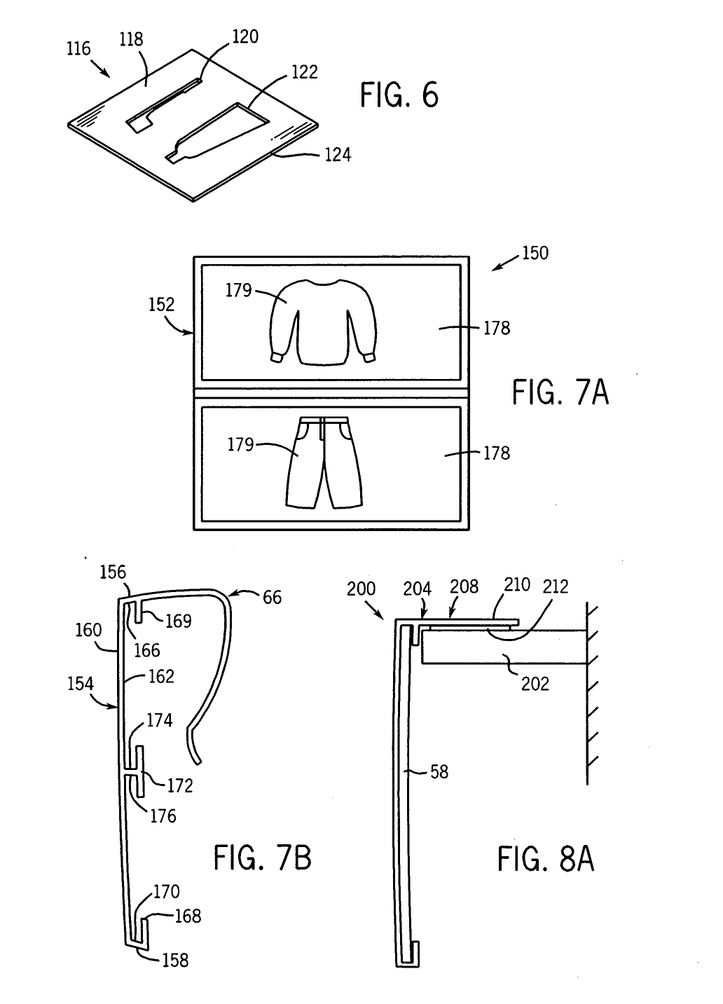

Turning for the moment to FIG. 6, an alternate, one layer insert 116 in accordance with the present invention is illustrated. The insert 116 has a front face 118 bearing a visual sign, indicia, symbol, image or other picture 120 and 122 such as a clothing, household and/or personal item (for example, a toothbrush and toothpaste are illustrated on the insert 116). The insert 116 also can contain a back face 124 that preferably includes a visual sign, indicia, symbol, image or other picture such as a clothing, household and/or personal item applied thereto. The insert 116 may be constructed of any of the substrate materials described elsewhere herein and in any color, texture or pattern, as also described. The pictures 120 and 122 may be applied to the substrate material using any method known to those skilled in the art, such as printing, drawing, stitching or embossing.

Accordingly, the organizing system is utilized by selecting and/or preparing an insert bearing a picture of the item or items that are contained within the drawer or location on which the system 50 is to be installed. In addition, the color, design or pattern contained on the insert 58 can be coordinated to match the environment of the system (i.e. the room in which the system is installed). After selection of the insert is made and/or design of the insert is complete, the insert 58 is installed in the housing member 56 by sliding the top and bottom edges 95 and 97 of the insert 58 into the top and bottom channels 90 and 94 of the housing member 56, respectively. As described herein, the flanges 88 and 92 help to retain the insert 58 in place in the housing during use of the system.

The system 50 is then removably mounted to the dresser 54 by clipping the mounting portion 66 over the top edge of the drawer 52, as illustrated in FIGS. 1 and 3. When the system installed on the dresser, the display portion 64 of the housing member 56 is substantially flush with/parallel to the dresser drawer 52 and does not interfere with use of the dresser and/or cause unneeded interference or distraction in the individual's room. However, as illustrated in FIG. 2, because the display portion 64 of the housing member 56 is transparent, the visual signs, indicia, symbols, images, pictures 102 and/or cutouts 108 disposed on the front face 100 of the insert 58 will displayed on the outside face the drawer, identifying the contents of each of the drawers, and therefore, teaching the individual the correct location for the item and/or belonging.

When the system is no longer needed or is moved to a different location, it can be removed from the dresser 54 by grasping the end 72 of the housing member 56 and releasing the mounting portion 66 from the drawer 54. Likewise, the system 50 may be removed when the insert 58 is changed.

Accordingly, the present invention can be used in a number of different applications by simply changing the visual appearance of the insert 58. Indeed, the system 50 may be provided with a large number of inserts 58 to provide the user the ability to select the items, color and/or designs contained thereon. (The user may also be provided with the means to generate their own inserts, for example, by means of a software program and printing capability). As such, the system 50 is individually and personally configurable depending on a given application, the contents of the enclosure (the color and/or type of item contained therein) and/or the location of the system. Therefore, the system 50 can teach an individual to organize their belongings while also being configured to blend into the surroundings, if desired.

As such, it can be seen that the present invention can be used as a teaching system or kit for helping individuals organize their belongings containing a plurality of housing members 56 and a plurality of removable inserts 58. For example, a caregiver or parent may assist in setting up the system so that the inserts 58 contained within each of the housing members include items displayed thereon that match or correspond to the items contained within the drawer and/or that match or correspond to the surroundings/décor of the system environment.

The system provides immediate visual recognition/indication to the user of the contents of each of the drawers and instructs and enables the individual to put their belongings in the correct drawer. Further, through repetitive use of the system (i.e. repeated exposure to the pictures/images displayed on the front face of the housing member), the individual is able to organize, locate and put away their belongings without assistance.

Turning next to FIGS. 7A and 7B, an alternate embodiment of the present invention is illustrated. In particular, a system 150 includes a housing member 152 including a display portion 154 having a top side, indicated generally at 156, a bottom side, indicated generally at 158, a front face 160 and a rear face 162. A flange 164 extends downwardly from the top side 156 of the display portion 154 forming a channel 166 that extends the entire width of the housing member 152. Likewise, a flange 168 extends upwardly from the bottom side 158 of the display portion 154 forming a channel 170 extends the entire width of the housing member 152.

A T-shaped member 172, extending rearwardly from the rear face 162 of the display portion 154, forms channels 174 and 176 which extend the entire width of the housing member 152. Each of the pairs of channels 166 and 174, and 176 and 170 are sized to fit and retain an insert 178, such that the system 150 can retain two inserts at the same time. The insert 178 may be of the same construction as the insert 58 described elsewhere herein, however, sized to be retained within the channels of the housing member 150. The inserts 178 each contain a picture 179 of a clothing item. It will be appreciated by those skilled in the art that the system of the present invention may be designed to retain any number of inserts, depending on the given end-use application, by simply including additional channel and/or T-shaped members.

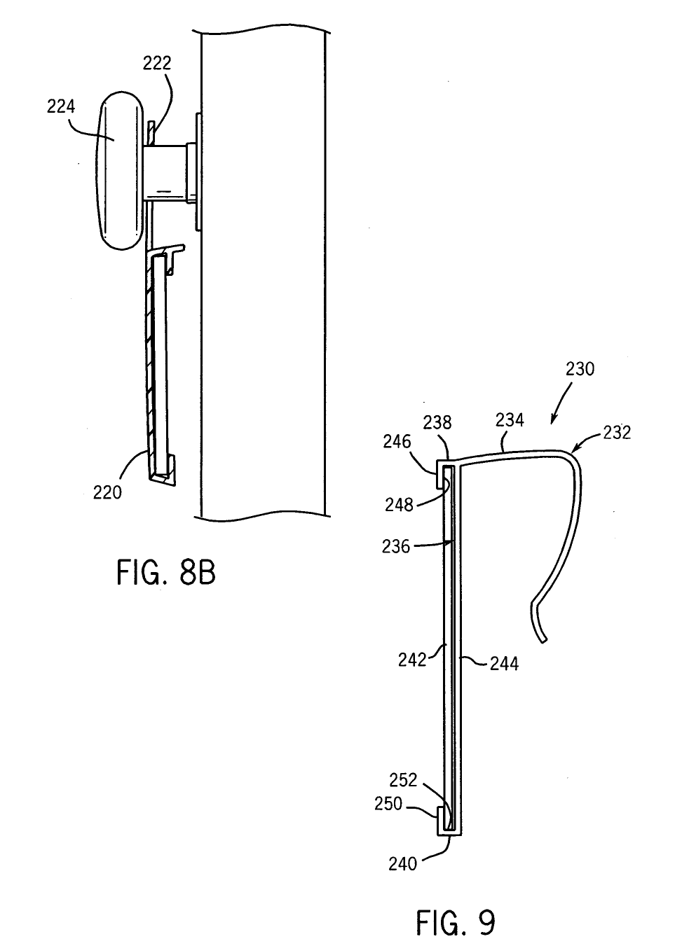

FIG. 8A illustrates another embodiment of the present invention including a system 200 for teaching organizational skills to individuals that is mounted to a shelf 202. The system 200 includes a housing member 204 having a display portion 206 that is substantially similar to the display portion 64, described with reference to the system 50 of the present invention, and configured to retain an insert 58, such as those described with reference to FIGS. 5A-C and 6. The housing member 204 further includes a mounting portion 208 comprising a flat flange 210 that rests on the shelf 202. The system 200 may be removably retained in place on the shelf using nonpermanent adhesive, a hoop and loop type fastener (such as Velcro), magnets or by any removable yet securable means known to those skilled in the art.

As demonstrated by FIG. 8A and consistent with the broader aspects of the present invention, the organizing system of the present invention may be removably mounted to the drawer, shelf, cabinet, box, appliance or other enclosure by any mounting system known to those skilled in the art, provided the item displayed on the insert is readily visible to the individual and provided the mounting portion does not interfere with normal operation of such container, enclosure, etc. Accordingly, the mounting portion of the system of the present invention may comprise any structural or mechanical means for removably securing the device to a drawer, shelf, cabinet, box or other enclosure. For example, as illustrated in FIG. 8B, a system 220 of the present invention may include a mounting portion 222 such as a hook, loop or elastic band that wraps around, clips on to or is otherwise secured to the knobs 224 or handles of the item.

Turning for the moment to FIGS. 8C and 8D, an additional system 225 of the present invention is illustrated. In particular, the system 225 includes a housing member 226 having a display portion 227 configured to retain an insert 58, such as those described with reference to FIGS. 5A-C and 6. The display portion 227 includes first and second layers 228 and 229, respectively, preferably joined at the top and bottom portions thereof but not at least one of the sides thereof, such that the layers are adjacent to each other, yet providing a space 231 between the layers configured to slidably receive the insert 58 therebetween. At least the first layer 228 of the display portion 227 is constructed of a substantially transparent material so that the item displayed on the insert 58 may be viewed from the exterior face of the drawer. As illustrated in FIG. 8C, the display portion can be of any shape (circular, square, diamond, triangle) or size, depending on the specific application for the system and/or type of furniture, appliance, etc. onto which it is secured.

As illustrated in FIG. 8D, the housing member 226 further includes a mounting portion 233 that permits the system 225 to be used as a drawer pull, handle or knob, such that the display portion 227 is used both to indicate the contents of the drawer, but also used to open the drawer. Accordingly, the mounting portion 233 can include a leg 235 that extends through the face of the drawer and mounting hardware 237 such as a screw or nail. It will be appreciated by those skilled in the art, the mounting portion 233 can be of any type or size available to be used as a drawer pull, handle or knob, as will be well known to those skilled in the art—including mounting portions configured for a specific furniture design, brand or type, depending on the end-use application of the system.

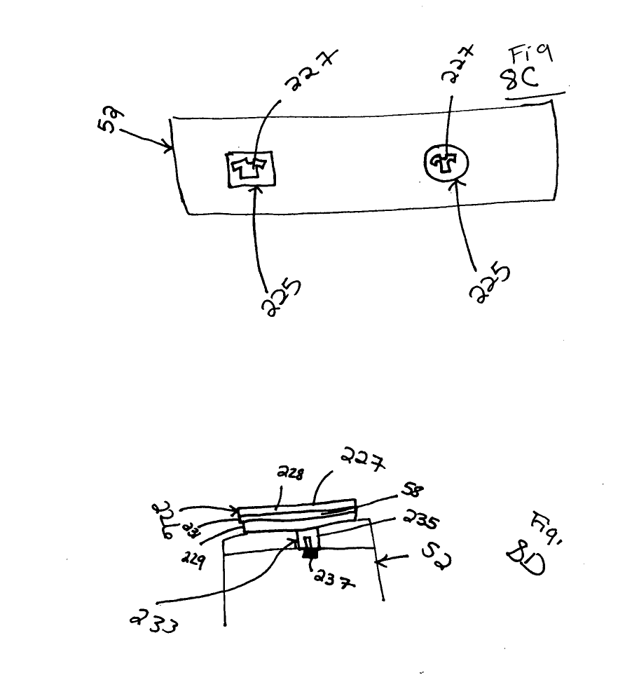

FIG. 9 illustrates a further embodiment of the system for teaching organizing skills of the present invention. The system 230 includes a housing member 232 having a mounting portion 234 that is substantially similar to the display portion 66 described with reference to the system 50 of the present invention. The housing member 232 further includes a display portion 236 having a top side, indicated generally at 238, a bottom side, indicated generally at 240, a front face 242 and a rear face 244. A flange 246 extends downwardly from the top side 238 of the display portion 236, forming a channel 248 that extends the entire width of the housing member 232. Likewise, a flange 250 extends upwardly from the bottom side 240 of the display portion 236, forming a channel 252 that extends the entire width of the housing member 232. Each of the channels 248 and 252 are sized to fit and retain the insert 58, as those described with reference to FIGS. 5A-C and 6. It will be appreciated that the embodiment described with reference to FIG. 9 need not be constructed of a transparent or substantially transparent material because the insert 58 is removably positioned in front of the housing member 252.

It may therefore be seen that the present invention provides an organizing device and method for enabling an individual to learn the correct location for an item (such as a clothing or personal item) in a drawer, container and/or shelf and for helping the individual organize their belongings—thereby assisting in the independence of individuals with special needs, young children and/or the organizationally challegenged. The present invention further provides a system for organizing the contents of a drawer, container and/or shelf that is removably located on the outside of or conveniently on the inside of the drawer, shelf or container to facilitate recognition by the individual of the contents of the drawer and/or to teach the individual the proper location for such items within the drawer. Accordingly, the system of the present invention provides a visual signal/indication to the individual the correct location for the item.

It may therefore be seen that the present invention provides a method for teaching organizational skills to an individual with special needs, by providing a removable organizing device configured to secure to a drawer, shelf or other storage container including a removable insert bearing indicia, emblems, colors and/or a picture that clearly displays an item or otherwise coordinates with the articles within the drawer, shelf, or other storage container. The system secures to the drawer in a manner that permits the individual to view the device thereon and recognize that the indicia/picture contained thereon corresponds to the items within the drawer. In this manner, the individual is taught the proper location for their items so that they may be put away and taken out without assistance.

Further, the information and/or visual pictures displayed on the device can be changed if the contents of the drawer change or the color, décor or environment changed by simply removing the insert and replacing the insert with another insert bearing the desired picture and/or indicia. The system of the present invention is adjustable so that it may be clipped or otherwise secured to more than one size drawer, shelf, enclosure and/or piece of furniture in the individuals home or office.

Although the foregoing description of the present invention has been shown and described with reference to particular embodiments and applications 10 thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A system for teaching the correct location of one or more personal items that are kept in a drawer having an exterior face, the system comprising:
a substantially flat display portion having a height dimension, a width dimension, a top edge, a bottom edge, a front surface and a rear surface, the rear surface of the display portion including a downwardly disposed member extending outwardly from the top edge thereof and forming a top channel and an upwardly disposed member extending outwardly from the bottom edge thereof and forming a bottom channel that is substantially parallel to the top channel, each of the channels extending the entire width of the display portion channels;
a mounting portion integrally formed and extending rearwardly from the rear surface of one of the top and bottom edges of the display portion, the mounting portion including a channel member having a top surface that is sized to fit over the top edge of the drawer and a downwardly extending leg that angles towards the display portion; and
a removable insert having a first surface and a second surface, wherein at least one of the first and the second surfaces bears an image of at least one of the personal items kept in the drawer, the removable insert also including a top edge slidably received within the top channel of the display portion and a bottom edge slidably received within the bottom channel of the display portion, wherein the image of the least one of the personal items kept in the drawer is displayed on the exterior face of the drawer.

2. The system of claim 1, wherein the display portion and the mounting portion are formed of a transparent or substantially transparent thermoplastic material.

3. The system of claim 1, wherein the removable insert comprises one or more layers of material overlying each other, wherein at least one of the layers includes a stencil of the image of the at least one personal item kept in the drawer.

4. The system of claim 3, wherein at least one of the layers of material is constructed of a different color than the remaining layers.

5. The system of claim 1, wherein the removable insert comprises a single layer of material.

6. The system of claim 1, wherein the removable insert is constructed of paper, plastic, wood, metal or a composite thereof.

7. An organizing system for visually identifying the location of items in one of a drawer, shelf, box or other enclosure, the system comprising:
a housing member comprising a display portion having a top edge, a bottom edge, a front side and a back side and a mounting mechanism secured to the back side end extending from one of the top edge and the bottom edge of the display portion; and
a substantially two dimensional substrate formed from one or more layers of material, the substrate secured to one of the front and back sides of the display portion, the substrate having a surface bearing a picture of the item located in the drawer.

8. The system of claim 7, wherein the display portion is constructed of a transparent material and wherein the picture is secured to the back side of the display portion.

9. The system of claim 7, wherein the display portion is constructed of an opaque material and wherein the picture is secured to the front side of the display portion.

10. The system of claim 7, wherein the display portion comprises:
a downwardly disposed channel forming member provided within the top edge of the display portion on either the front or back side thereof;
an upwardly disposed channel forming member provided within the bottom edge of the display portion on the same side as the downwardly disposed channel member, the channels of the channel forming member being oriented parallel to each other; and wherein the substrate in slidably received within the channels.

11. The system of claim 7, wherein the mounting mechanism comprises a channel member having a top surface that is sized to fit over the top edge of the drawer and a downwardly extending leg that angles towards the display portion.

12. The system of claim 7, wherein the mounting mechanism comprises a bracket configured to about a surface of a shelf.

13. The system of claim 7, wherein at least one of the layers of the substrate includes a stencil of the image of the at least one personal item.

14. The system of claim 7, wherein at least one of the layers of material is constructed of a different color than the remaining layers.

15. The system of claim 7, wherein the substrate comprises a single layer of material.

16. The system of claim 7, wherein the substrate is constructed of paper, plastic, wood, metal or a composite thereof.

17. A method for teaching the correct location of one or more personal items that are kept in a drawer having an exterior face, the method comprising:
providing a teaching system having a mounting portion and a display portion, the display portion having a front surface and a rear surface, the rear surface of the display portion including a downwardly disposed member extending outwardly from the top edge thereof and forming a top channel and an upwardly disposed member extending outwardly from the bottom edge thereof and forming a bottom channel that is substantially parallel to the top channel, each of the channels extending the entire width of the display portion channels;
providing a removable insert having a first surface and a second surface, wherein at least one of the first and the second surfaces bears an image of at least one of the personal items kept in the drawer;
positioning the removable insert into the teaching system by sliding a top edge of the insert into the top channel of the display portion and sliding a bottom edge of the insert into the bottom channel of the display portion; and
removably securing the mounting portion of the system to the drawer, wherein the image of the at least one of the personal items kept in the drawer is displayed on the exterior face of the drawer and wherein the image is visually recognizable to the human eye as the at least one of the personal items kept in the drawer.
